(19) United States
(12) Patent Application Publication
(10) Pub. No.: US 2026/0229639 A1
(43) Pub. Date: Aug. 6, 2026

(54) BATTERY COOLER AND BATTERY UNIT

(71) Applicant: TOYODA GOSEI CO., LTD., Kiyosu-shi (JP)

(72) Inventors: Kohei AKAI, Kiyosu-shi (JP); Musashi SUZUKI, Kiyosu-shi (JP)

(21) Appl. No.: 19/443,102

(22) Filed: Jan. 8, 2026

(30) Foreign Application Priority Data
Feb. 3, 2025 (JP) 2025-016184

(51) Int. Cl. H01M 10/6557; H01M 10/613; H01M 50/249

(52) U.S. Cl. CPC H01M 10/6557; H01M 10/613; H01M 50/249

(57) ABSTRACT

A battery cooler disposed between two battery cells adjacent in a predetermined direction includes an outer wall that forms an internal space including a cooling passage, and is deformable in a flexural manner in the predetermined direction. The outer wall includes a first plate part that faces one of the battery cells, and a second plate part that faces the other battery cell. Each of the first and second plate parts includes a contact portion in contact with an outer surface of the battery cell, and a non-contact portion that is not in contact with the outer surface of the battery cell, and forms a gap allowing expansion deformation of the battery cell. The non-contact portions of the plate parts are not in contact with each other, and prevent stress concentration to the cooler when the battery cell expands.

### TECHNICAL FIELD

The present disclosure relates to a battery cooler and a battery unit.

### BACKGROUND ART

Conventionally, a battery unit in which a plurality of battery cells are arranged side by side in a predetermined direction has been known (refer to Japanese Laid-Open Patent Publication No. 2022-53008, for example). The battery unit includes a cooler disposed between two battery cells adjacent in the predetermined direction. The cooler includes two plate parts, each extending two-dimensionally, and the two plate parts face each other in the predetermined direction across an internal space. A cooling passage through which a cooling fluid flows is formed in the internal space. According to the structure of the battery unit, the battery cells are cooled with the cooling fluid that flows through the cooling passage of the cooler.

In the above cooler, one of the two plate parts is in contact with the outer surface of the battery cell on one side in the predetermined direction, while the other plate part is in contact with the outer surface of the battery cell on the other side in the predetermined direction. Each of the two plate parts is deformable in a flexural manner in the predetermined direction, and is deformable toward the internal space side in response to expansion of the battery cell.

The above cooler includes an extension part that extends in the predetermined direction in the internal space between two plate parts. The extension part is disposed at both ends in an intersecting direction that intersects the predetermined direction in which the two plate parts face each other. The extension part has a function of preventing deformation of the plate parts in response to a vibration input in the predetermined direction of the battery cells. Each plate part is in contact with the outer surface of the corresponding battery cell over substantially the entire region in the intersecting direction, and is deformed in a flexural manner in the predetermined direction between the two extension parts.

### SUMMARY OF INVENTION

### TECHNICAL PROBLEM

In the structure of the above cooler, however, the extension part exists as a rigid body between the two plate parts. Therefore, when the battery cell expands, stress caused by the expansion is concentrated in the extension part. As a result, there is a risk that the extension part may plastically deform under the expansion force of the battery cell, or a reaction force restraint load from the cooler to the battery cell may become excessively high. After such plastic deformation of the extension part has occurred, it becomes difficult to ensure shape followability associated with flexural deformation of the plate part under the situation where expansion and contraction of the battery cell are repeated. On the other hand, when the reaction force restraint load is excessively high, a problem may occur in which the battery cell is damaged.

The present disclosure has been made in view of the above circumstances, and an object of the present disclosure is to make a cooler less likely to be plastically deformed and make a battery cell less likely to be damaged, by dispersing stress applied to the cooler when the battery cell expands.

### SOLUTION TO PROBLEM

One aspect of the present disclosure is a battery cooler provided in a battery unit. The battery unit includes: two or more battery cells arranged side by side in a predetermined direction with a predetermined space interposed therebetween; and a restraint member that restrains the battery cells from relatively moving in the predetermined direction. The battery cooler is disposed in the predetermined space between the two battery cells adjacent in the predetermined direction. The battery cooler includes an outer wall that forms an internal space including a cooling passage through which a cooling fluid flows, and is deformable in a flexural manner in the predetermined direction. The outer wall includes: a first plate part that faces one of the battery cells in the predetermined direction; and a second plate part that faces the other battery cell in the predetermined direction, and faces the first plate part across the internal space in the predetermined direction. The first plate part includes: a first contact portion that is in contact with an outer surface of the one of the battery cells; and a first non-contact portion that is continuous with the first contact portion, forms a first gap, with the one of the battery cells, allowing expansion deformation of the one of the battery cells, and is not in contact with an outer surface of the one of the battery cells. The second plate part includes: a second contact portion that is in contact with an outer surface of the other battery cell; and a second non-contact portion that is continuous with the second contact portion, forms a second gap, with the other battery cell, allowing expansion deformation of the other battery cell, is not in contact with the outer surface of the other battery cell, and is not in contact with an inner surface of the first non-contact portion.

Furthermore, one aspect of the present disclosure is a battery unit including: two or more battery cells arranged side by side in a predetermined direction with a predetermined space interposed therebetween; a cooler disposed in the predetermined space between the two battery cells adjacent in the predetermined direction; and a restraint member that restrains the battery cells from relatively moving in the predetermined direction. The cooler includes an outer wall that forms an internal space including a cooling passage through which a cooling fluid flows, and is deformable in a flexural manner in the predetermined direction. The outer wall includes: a first plate part that faces one of the battery cells in the predetermined direction; and a second plate part that faces the other battery cell in the predetermined direction, and faces the first plate part across the internal space in the predetermined direction. The first plate part includes: a first contact portion that is in contact with an outer surface of the one of the battery cells; and a first non-contact portion that is continuous with the first contact portion, forms a first gap, with the one of the battery cells, allowing expansion deformation of the one of the battery cells, and is not in contact with an outer surface of the one of the battery cells. The second plate part includes: a second contact portion that is in contact with an outer surface of the other battery cell; and a second non-contact portion that is continuous with the second contact portion, forms a second gap, with the other battery cell, allowing expansion deformation of the other battery cell, is not in contact with the outer surface of the other battery cell, and is not in contact with an inner surface of the first non-contact portion.

According to the above configurations, the stress applied to the cooler when the battery cell expands is dispersed, thereby making the cooler less likely to be plastically deformed and making the battery cell less likely to be damaged.

### BRIEF DESCRIPTION OF DRAWINGS

FIG. 1 schematically shows a configuration of a battery unit according to an embodiment of the present disclosure;

FIG. 2 shows a configuration of a cooler included in the battery unit of the present embodiment;

FIG. 3 is a cross-sectional view of the cooler of the present embodiment taken along III-III in FIG. 2;

FIG. 4 is an enlarged cross-sectional view of a main part of the cooler of the present embodiment; and

FIG. 5 illustrates the function of the cooler of the present embodiment.

### DESCRIPTION OF EMBODIMENTS

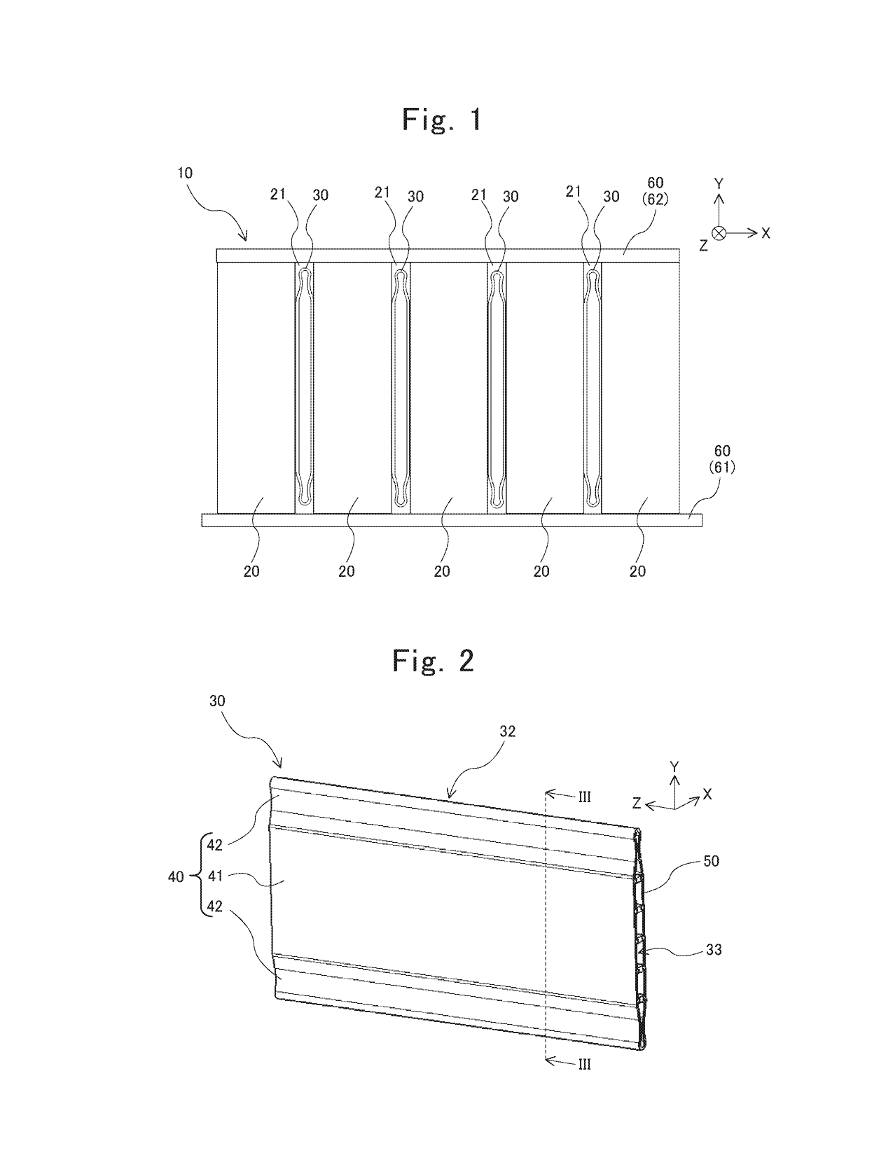

Hereinafter, a specific embodiment of a battery unit and a battery cooler according to the present disclosure will be described with reference to FIGS. 1 to 5.

A battery unit 10 according to the embodiment is, for example, a unit that functions as a battery for traveling of a vehicle, as shown in FIG. 1. The vehicle in which the battery unit 10 is installed is an electric vehicle, a plug-in hybrid vehicle, or the like.

The battery unit 10 is, for example, a lithium ion battery or a nickel-metal hydride battery. The battery unit 10 includes battery cells 20, coolers 30, and restraint members 60, as shown in FIG. 1.

The battery cells 20 are cells constituting a battery, and each battery cell 20 may be a single cell or a part of a single cell that constitutes a stacked type battery. The battery cell 20 may be a cell that constitutes a monopolar battery, or may be a cell that constitutes a bipolar battery. The battery cell 20 is a secondary battery capable of repeating charging and discharging. The battery cell 20 is formed in a prism shape, for example.

The battery unit 10 is composed of two or more battery cells 20. That is, two or more battery cell 20 are provided in the battery unit 10. The two or more battery cells 20 are arranged side by side in a predetermined direction X with a predetermined space 21 therebetween. The two or more battery cells 20 are electrically connected to each other in series or in parallel.

The battery cells 20 are restrained in the predetermined direction X by the restraint members 60, as shown in FIG. 1. That is, the restraint members 60 are members that restrain relative movement of the battery cells 20 in the predetermined direction X. The restraint members 60 are composed of case members 61, 62 each being formed in a plate shape or a square-bar shape extending in the predetermined direction X. The case members 61, 62 are disposed so as to sandwich the battery cells 20 in an intersecting direction Y that intersects the predetermined direction X (specifically, an orthogonal direction orthogonal to the predetermined direction X). Each battery cell 20 is restrained by being joined to the case members 61, 62 at some surfaces thereof (in FIG. 1, upper and lower surfaces) with an adhesive or the like.

The coolers 30 are battery coolers for cooling the battery cells 20. The coolers 30 circulate a cooling fluid to cause heat exchange between the cooling fluid and the battery cells 20, thereby suppressing the temperature rise of the battery cells 20. As shown in FIG. 2, a cooler 30 is a member that is formed in a plate shape and has a cooling passage 31 in which the cooling fluid flows. The cooler 30 is disposed in a predetermined space 21 between two battery cells 20 adjacent in the predetermined direction X. The cooler 30 is provided for each predetermined space 21 between two battery cells 20 adjacent in the predetermined direction X. Each cooler 30 is preferably restrained by or fixed to the restraint members 60 or the battery cells 20 in order to prevent the cooler 30 from coming off from the predetermined space 21.

As shown in FIG. 2, the cooler 30 has an outer wall 32. The outer wall 32 is a wall member extending in a plate shape. The outer wall 32 surrounds the cooling passage 31 and forms an internal space 33 including the cooling passage 31. The cooling passage 31 may be a part of the entire region of the internal space 33, or may be the entire region. The outer wall 32 is formed of a metal material such as aluminum. The outer wall 32 is provided with an inlet and an outlet connected to the cooling passage 31.

The outer wall 32 extends so as to include a plane including two directions orthogonal to the predetermined direction X. The outer wall 32 has a predetermined thickness. The predetermined thickness is set within a range from 0.5 mm to 2.0 mm, for example. The outer wall 32 is formed such that the thickness is substantially uniform over the entire region of the outer wall 32. The outer wall 32 deforms in a flexural manner in the predetermined direction X in which the battery cells 20 are arranged side by side. However, the outer wall 32 is preferably as thin as possible in order to disperse stress applied from the outside (specifically, the battery cells 20).

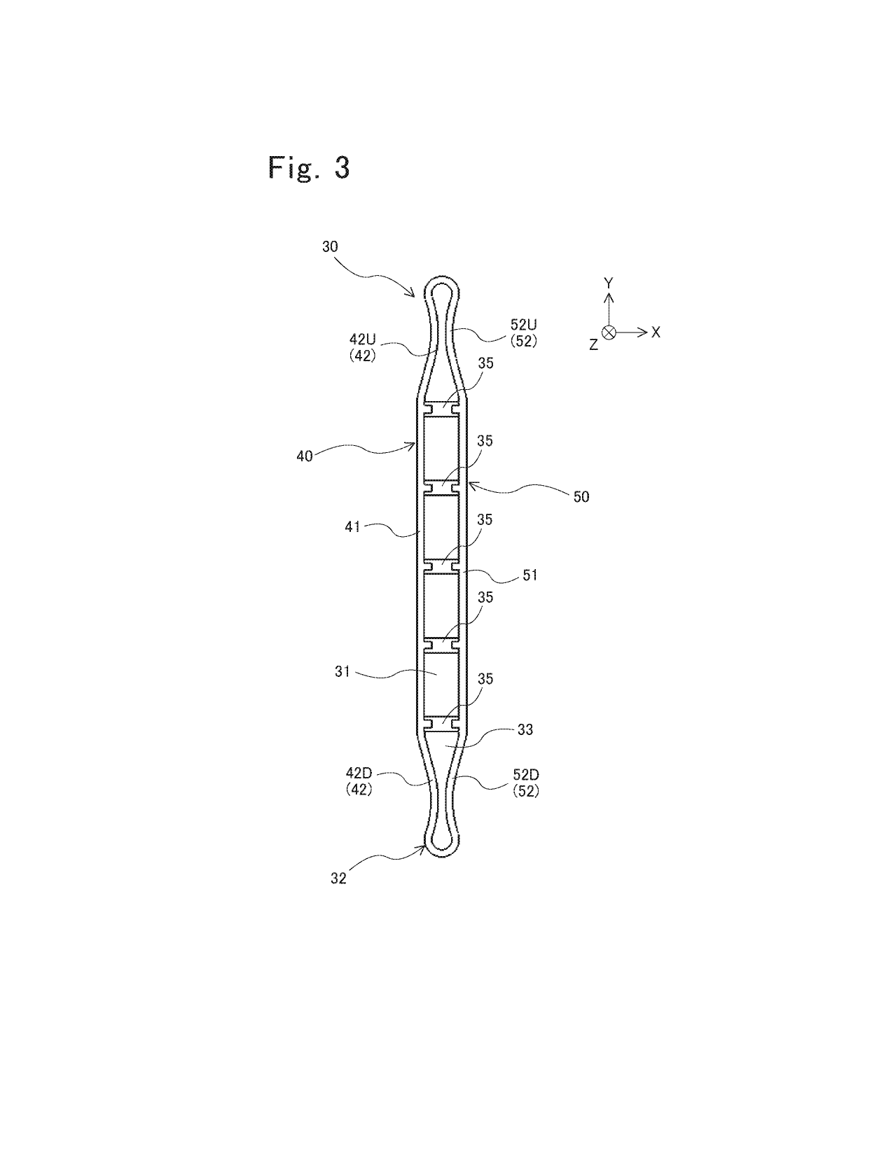

As shown in FIG. 3, the outer wall 32 includes a first plate part 40 and a second plate part 50.

The first plate part 40 is a plate part that faces, in the predetermined direction X, one of the two battery cells 20 that form the predetermined space 21 in which the cooler 30 is disposed. The second plate part 50 is a plate part that faces, in the predetermined direction X, the other one of the two battery cells 20 that form the predetermined space 21 in which the cooler 30 is formed. Hereinafter, for convenience, one (left-side in FIG. 3) battery cell 20 with respect to a specific cooler 30 is referred to as a one-side battery cell 20L, while the other (right-side in FIG. 3) battery cell 20 with respect to the specific cooler 30 is referred to as the other-side battery cell 20R.

The first plate part 40 and the second plate part 50 are connected to each other and integrated with each other at the both ends in the intersecting direction Y that intersects the predetermined direction X. The first plate part 40 comes into contact with the one-side battery cell 20L, and is elastically deformed due to a pressing force caused by expansion of the one-side battery cell 20L. The second plate part 50 comes into contact with the other-side battery cell 20R, and is elastically deformed due to a pressing force caused by expansion of the other-side battery cell 20R.

The first plate part 40 and the second plate part 50 face each other in the predetermined direction X with the internal space 33 therebetween. The first plate part 40 and the second plate part 50 are formed and disposed so as not to come into contact with each other, even when the one-side battery cell 20L and the other-side battery cell 20R expand to the maximum extent. That is, the size of the internal space 33 between the first plate part 40 and the second plate part 50 is configured such that the plate parts 40 and 50 do not come into contact with each other, even when the one-side battery cell 20L and the other-side battery cell 20R expand to the maximum extent.

The first plate part 40 includes a first contact portion 41 and a first non-contact portion 42. The first contact portion 41 is a portion in contact with the outer surface, on the other-side battery cell 20R side, of the one-side battery cell 20L. The first contact portion 41 is formed in a plate shape, and extends along and in parallel with the outer surface of the one-side battery cell 20L. The first contact portion 41 is provided at the center, in the intersecting direction Y, of the first plate part 40.

The first non-contact portion 42 is a portion not in contact with the outer surface, on the other-side battery cell 20R side, of the one-side battery cell 20L. The first non-contact portion 42 is formed continuously with the first contact portion 41. The first non-contact portion 42 is formed such that the length thereof in the intersecting direction Y in the first plate part 40 accounts for 10% to 30% of the entire length of the first plate part 40. The length in the intersecting direction Y of the first non-contact portion 42 (if the first non-contact portion 42 is divided into two portions as described below, a total value of the lengths of the two first non-contact portions 42) is set to, for example, 10 mm to 20 mm.

The first non-contact portion 42 is formed and disposed so as not to come into contact with the outer surface of the one-side battery cell 20L, even when the one-side battery cell 20L expands to the maximum extent. Between the first non-contact portion 42 and the one-side battery cell 20L, a first gap 43 that tolerates expansion deformation of the one-side battery cell 20L is formed. The first gap 43 is configured such that the first non-contact portion 42 and the one-side battery cell 20L do not come into contact with each other, even when the one-side battery cell 20L expands to the maximum extent.

The first non-contact portion 42 is provided at both ends in the intersecting direction Y of the first plate part 40. Two first non-contact portions 42 are provided in the first plate part 40, spaced apart in the intersecting direction Y. Hereinafter, the first non-contact portion 42 on one end side in the intersecting direction Y (upper side in FIGS. 1 and 3) is referred to as one end-side first non-contact portion 42U, while the first non-contact portion 42 on the other end side in the intersecting direction Y (lower side in FIGS. 1 and 3) is referred to as the other end-side first non-contact portion 42D. The one end-side first non-contact portion 42U and the other end-side first non-contact portion 42D are disposed spaced apart in the intersecting direction Y with the first contact portion 41 interposed therebetween. The one end-side first non-contact portion 42U and the other end-side first non-contact portion 42D are disposed and configured in a symmetrical manner with the first contact portion 41 interposed therebetween.

The second plate part 50 includes a second contact portion 51 and a second non-contact portion 52. The second contact portion 51 is a portion in contact with the outer surface, on the one-side battery cell 20L side, of the other-side battery cell 20R. The second contact portion 51 is formed in a plate shape, and extends along and in parallel with the outer surface of the other-side battery cell 20R. The second contact portion 51 is provided at the center, in the intersecting direction Y, of the second plate part 50.

The second non-contact portion 52 is a portion not in contact with the outer surface, on the one-side battery cell 20L side, of the other-side battery cell 20R. The second non-contact portion 52 is formed continuously with the second contact portion 51. The second non-contact portion 52 is formed such that the length thereof in the intersecting direction Y in the second plate part 50 accounts for 10% to 30% of the entire length of the second plate part 50. The length in the intersecting direction Y of the second non-contact portion 52 (if the second non-contact portion 52 is divided into two portions as described below, a total value of the lengths of the two second non-contact portions 52) is set to, for example, 10 mm to 20 mm.

The second non-contact portion 52 is formed and disposed so as not to come into contact with the outer surface of the other-side battery cell 20R, even when the other-side battery cell 20R expands to the maximum extent. Between the second non-contact portion 52 and the other-side battery cell 20R, a second gap 53 that tolerates expansion deformation of the other-side battery cell 20R is formed. The second gap 53 is configured such that the second non-contact portion 52 and the other-side battery cell 20R do not come into contact with each other, even when the other-side battery cell 20R expands to the maximum extent.

The second non-contact portion 52 is provided at both ends in the intersecting direction Y of the second plate part 50. Two second non-contact portions 52 are provided in the second plate part 50, spaced apart in the intersecting direction Y. Hereinafter, the second non-contact portion 52 on one end side in the intersecting direction Y (upper side in FIGS. 1 and 3) is referred to as one end-side second non-contact portion 52U, while the second non-contact portion 52 on the other end side in the intersecting direction Y (lower side in FIGS. 1 and 3) is referred to as the other end-side second non-contact portion 52D. The one end-side second non-contact portion 52U and the other end-side second non-contact portion 52D are disposed spaced apart in the intersecting direction Y with the second contact portion 51 interposed therebetween. The one end-side second non-contact portion 52U and the other end-side second non-contact portion 52D are disposed and configured in a symmetrical manner with the second contact portion 51 interposed therebetween.

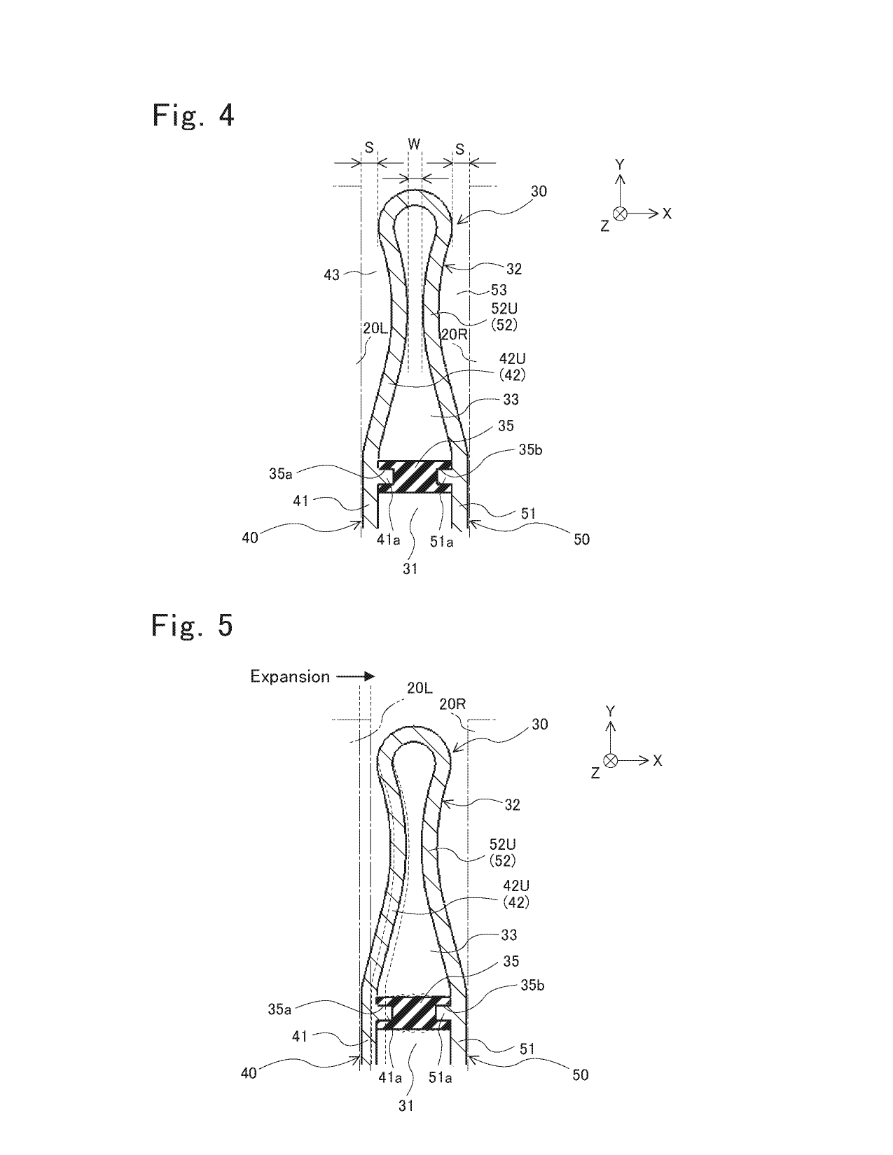

One end in the intersecting direction Y of the one end-side first non-contact portion 42U of the first plate part 40, and one end in the intersecting direction Y of the one end-side second non-contact portion 52U of the second plate part 50 are connected to each other and integrated. Except at the one end in the intersecting direction Y, the one end-side first non-contact portion 42U and the one end-side second non-contact portion 52U are not connected to each other, and the inner surfaces thereof face each other with a gap (having a size W shown in FIG. 4). One end in the intersecting direction Y of the other end-side first non-contact portion 42D of the first plate part 40, and one end in the intersecting direction Y of the other end-side second non-contact portion 52D of the second plate part 50 are connected to each other and integrated. Except at the one end in the intersecting direction Y, the other end-side first non-contact portion 42D and the other end-side second non-contact portion 52D are not connected to each other, and the inner surfaces thereof face each other with a gap (having a size W in FIG. 4).

Each of the one end-side first non-contact portion 42U and the other end-side first non-contact portion 42D is formed in an arcuate shape so as to be deformable in a flexural manner in the predetermined direction X, from a boundary portion connected to the first contact portion 41 to a distal end portion in the intersecting direction Y. Each of the one end-side second non-contact portion 52U and the other end-side second non-contact portion 52D is formed in an arcuate shape so as to be deformable in a flexural manner in the predetermined direction X, from a boundary portion connected to the second contact portion 51 to a distal end portion in the intersecting direction Y.

Each of the first gap 43 and the second gap 53 is configured such that a size S smoothly changes according to the position in the intersecting direction Y. Specifically, the first gap 43 is configured such that the size S gradually increases from zero, from the boundary portion between the first contact portion 41 and the first non-contact portion 42 toward the distal end portion in the intersecting direction Y, then gradually decreases, and further gradually increases again. The second gap 53 is configured such that the size S gradually increases from zero, from the boundary portion between the second contact portion 51 and the second non-contact portion 52 toward the distal end portion in the intersecting direction Y, then gradually decreases, and further gradually increases again.

The one end-side first non-contact portion 42U and the one end-side second non-contact portion 52U are formed so as to curve and extend such that the separation distance in the predetermined direction X sequentially changes in the order of large → small → large, from the boundary portion connected to the first contact portion 41 or the second contact portion 51 toward the distal end portion on one side in the intersecting direction Y, and to be connected to each other at one end in the intersecting direction Y. Furthermore, the other end-side first non-contact portion 42D and the other end-side second non-contact portion 52D are formed so as to curve and extend such that the separation distance in the predetermined direction X sequentially changes in the order of large → small → large, from the boundary portion connected to the first contact portion 41 or the second contact portion 51 toward the distal end portion on the other end side in the intersecting direction Y, and to be connected to each other at the other end in the intersecting direction Y.

The cooler 30 includes an elastic body 35. The elastic body 35 is a member elastically deformable in the predetermined direction X. The elastic body 35 is formed of a rubber material such as polyurethane, for example. The elastic body 35 is disposed in the internal space 33, and is interposed between an inner surface of the first contact portion 41 facing the internal space 33, and an inner surface of the second contact portion 51 facing the internal space 33. The elastic body 35 is formed in a thin plate shape that extends in the predetermined direction X, and extends in a depth direction Z orthogonal to both the predetermined direction X and the intersecting direction Y.

When the first plate part 40 and the second plate part 50 are pressed inward in the predetermined direction X, i.e., toward the internal space 33 side, due to expansion of the battery cell 20, the elastic body 35 contracts in the predetermined direction X and applies a reaction force to the first plate part 40 and the second plate part 50. The elastic body 35 is restored to the original state when the above pressing force is removed.

The elastic body 35 is disposed at a plurality of positions (five positions in FIG. 3) in the internal space 33, spaced apart in the intersecting direction Y. The elastic bodies 35 adjacent in the intersecting direction Y are disposed spaced apart by a predetermined distance so as to form the cooling passage 31 through which a cooling fluid flows. The plurality of elastic bodies 35 partition the internal space 33 into a plurality of spaces so that a plurality of (four in FIG. 3) cooling passages 31 are formed. In other words, the cooling passages 31 are defined by the plurality of elastic bodies 35 in the internal space 33. The plurality of cooling passages 31 only need to be in communication with each other at any point along the depth direction Z.

As shown in FIG. 4, a projection 41a is provided at the inner surface of the first contact portion 41. The projection 41a is provided at a plurality of positions spaced apart in the intersecting direction Y. Also, a projection 51a is provided at the inner surface of the second contact portion 51. The projection 51a is provided at a plurality of positions spaced apart in the intersecting direction Y. Each projection 51a is disposed at a position corresponding to the above projection 41a. Each of the projections 41a, 51a projects inward, i.e., toward the internal space 33 side, in the predetermined direction X from the inner surface of the first contact portion 41 or the second contact portion 51. The projections 41a, 51a each extend in the depth direction Z.

Each elastic body 35 is attached to the projection 41a of the first contact portion 41, and attached to the projection 51a of the second contact portion 51. Each elastic body 35 has grooves 35a, 35b. Each of the grooves 35a, 35b is formed at the surface, of the elastic body 35, exposed outward in the predetermined direction X. The groove 35a is formed to correspond to the projection 41a. The groove 35b is formed to correspond to the projection 51a. In assembling the cooler 30, the elastic body 35 is inserted in the internal space 33 from the outside in the depth direction Z such that the grooves 35a, 35b are fitted to the projections 41a, 51a.

Each elastic body 35 may be adhered to the inner surface of the first contact portion 41 and the inner surface of the second contact portion 51 by using an adhesive or the like, instead of being attached to the projection 41a of the first contact portion 41 and the projection 51a of the second contact portion 51 as described above.

In the battery unit 10, the cooler 30 is disposed in the predetermined space 21 between two battery cells 20 adjacent in the predetermined direction X. In the cooler 30, the outer wall 32 forming the internal space 33 including the cooling passages 31 includes the first plate part 40 and the second plate part 50 facing each other in the predetermined direction X. The first plate part 40 and the second plate part 50 include the first contact portion 41 and the second contact portion 51 that are in contact with the outer surface of the battery cell 20, and the first non-contact portion 42 and the second non-contact portion 52 that are continuous with the first contact portion 41 and the second contact portion 51, respectively.

Unlike the first contact portion 41 and the second contact portion 51, the first non-contact portion 42 and the second non-contact portion 52 form, with the battery cell 20, the first gap 43 and the second gap 53 that allow expansion deformation of the battery cell 20, respectively, and are not in contact with the outer surface of the battery cell 20. The first non-contact portion 42 and the second non-contact portion 52 are connected to each other at both one end and the other end in the intersecting direction Y, but are not connected to each other at the other portion in the intersecting direction Y. At the other portion, the inner surfaces thereof face each other with a gap therebetween and are not in contact with each other.

In the above configuration of the battery unit 10, each battery cell 20 is in contact with the first contact portion 41 of the first plate part 40 that forms the outer wall 32 of the cooler 30 or the second contact portion 51 of the second plate part 50 that forms the outer wall 32. The outer wall 32 of the cooler 30 forms the internal space 33 including the cooling passages 31. When the cooling fluid flows through the cooling passages 31, cold air is transmitted from the cooling fluid to the outer surface of the battery cell 20 through the outer wall 32 of the cooler 30. Therefore, when the battery cell 20 becomes hot due to charging or the like, the battery cell 20 is cooled by the cooler 30.

In the configuration of the battery unit 10, when the battery cell 20 expands outward in the predetermined direction X due to charging of the battery unit 10, the outer surface of the battery cell 20 presses the first contact portion 41 or the second contact portion 51 of the cooler 30 toward the internal space 33 side in the predetermined direction X. When such a pressing force acts on the first contact portion 41 or the second contact portion 51, the cooler 30 is sandwiched between two battery cells 20 on both sides in the predetermined direction X, and the outer wall 32 deforms in a flexural manner in the predetermined direction X. The flexural deformation of the outer wall 32 is, as shown in FIG. 5, performed such that the first contact portion 41 and the second contact portion 51 are in contact with the outer surface of the battery cell 20, and the first non-contact portion 42 and the second non-contact portion 52 absorb the pressing force from the battery cell 20 without being in contact with each other and without being in contact with the outer surface of the battery cell 20.

In this configuration, since the cooler 30 does not exist as a rigid body between two battery cells 20, stress caused by expansion of the battery cells 20 is not concentrated in the cooler 30, but is dispersed. This prevents plastic deformation from occurring due to stress concentration in the cooler 30, and shape followability associated with flexural deformation of the outer wall 32 under the situation where expansion and contraction of the battery cell 20 are repeated is ensured, thereby preventing difficulty in shape followability of the outer wall 32 caused by plastic deformation of the cooler 30. In addition, during expansion of the battery cell 20, the reaction force restraint load from the cooler 30 to the battery cell 20 is kept low, thereby making the battery cell 20 less likely to be damaged.

Therefore, according to the present embodiment, the stress applied to the cooler 30 when the battery cell 20 expands is dispersed, thereby making the cooler 30 less likely to be plastically deformed, and making the battery cell 20 less likely to be damaged.

Furthermore, in the configuration of the battery unit 10, the cooler 30 includes the elastic body 35 interposed between the inner surface of the first plate part 40 of the outer wall 32 and the inner surface of the second plate part 50 of the outer wall 32. The elastic body 35 is elastically deformable in the predetermined direction X. In this configuration, when the outer wall 32 of the cooler 30 deforms in a flexural manner in the predetermined direction X due to expansion of the battery cell 20, the elastic body 35 applies an elastic force as reaction force from the cooler 30 to the battery cell 20, against the pressing force caused by expansion of the battery cell 20, thereby preventing the cooler 30 from being crushed against the expansion of the battery cell 20.

In the configuration of the cooler 30, the elastic bodies 35 partition the internal space 33 into a plurality of cooling passages 31 through which the cooling fluid flows. The cooling passages 31 are defined by the elastic bodies 35 at a plurality of locations in the internal space 33. Therefore, the elastic bodies 35 are caused to function as a reaction force generating means against expansion of the battery cell 20, and also function as partition plates that define the cooling passages 31, whereby effective utilization of the elastic body 35 is achieved, enabling cost reduction.

In the above embodiment, the outer wall 32 of the cooler 30 is formed such that the thickness thereof is substantially uniform over the entire region of the outer wall 32 (e.g., 0.5 mm to 2.0 mm). However, the present disclosure is not limited thereto, and the thickness of the outer wall 32 may be non-uniform over the entire region thereof. For example, the thickness of the first non-contact portion 42 of the outer wall 32 may be smaller than the thickness of the first contact portion 41, and the thickness of the second non-contact portion 52 may be smaller than the thickness of the second contact portion 51. According to this modification, it is possible to disperse the stress applied from the battery cell 20 in the first non-contact portion 42 and the second non-contact portion 52 while preventing the first contact portion 41 of the first plate part 40 and the second contact portion 51 of the second plate part 50 from excessively bending due to the pressing force caused by expansion of the battery cell 20.

In the above embodiment, in order to interpose the elastic body 35 of the cooler 30 between the first plate part 40 and the second plate part 50, the projections 41a, 51a are respectively provided on the inner surface of the first contact portion 41 and the inner surface of the second contact portion 51, and the grooves 35a, 35b are provided in the elastic body 35. However, the present disclosure is not limited thereto. If sufficient thicknesses of the first plate part 40 and the second plate part 50 are ensured, grooves may be provided at the inner surface of the first contact portion 41 and the inner surface pf the second contact portion 51, and projections may be provided on the elastic body 35.

The present disclosure is not limited to the above-described embodiment and modifications, and various changes may be made without departing from the gist of the present disclosure. In addition, the present specification discloses not only the technical concept according to the citation relationship recited in the claims as originally filed, but also the technical concept obtained by combining the matters recited in the claims as appropriate.

The present application claims priority from Japanese patent application No. 2025-016184 filed on Feb. 3, 2025, the entire contents of which are hereby incorporated by reference.

1. A battery cooler provided in a battery unit, the battery unit comprising: two or more battery cells arranged side by side in a predetermined direction with a predetermined space interposed therebetween; and a restraint member that restrains the battery cells from relatively moving in the predetermined direction, the battery cooler being disposed in the predetermined space between the two battery cells adjacent in the predetermined direction,
the battery cooler including an outer wall that forms an internal space including a cooling passage through which a cooling fluid flows, and is deformable in a flexural manner in the predetermined direction, wherein
the outer wall includes
a first plate part that faces one of the battery cells in the predetermined direction, and
a second plate part that faces the other battery cell in the predetermined direction, and faces the first plate part across the internal space in the predetermined direction,
the first plate part includes
a first contact portion that is in contact with an outer surface of the one of the battery cells, and
a first non-contact portion that is continuous with the first contact portion, forms a first gap, with the one of the battery cells, allowing expansion deformation of the one of the battery cells, and is not in contact with an outer surface of the one of the battery cells, and
the second plate part includes
a second contact portion that is in contact with an outer surface of the other battery cell, and
a second non-contact portion that is continuous with the second contact portion, forms a second gap, with the other battery cell, allowing expansion deformation of the other battery cell, is not in contact with the outer surface of the other battery cell, and is not in contact with an inner surface of the first non-contact portion.

2. The battery cooler according to claim 1, wherein
the first contact portion is provided at a center, in an intersecting direction that intersects the predetermined direction, of the first plate part,
the first non-contact portion is provided at both ends, in the intersecting direction, of the first plate part, and includes a one end-side first non-contact portion that is continuous with one end in the intersecting direction of the first contact portion, and another end-side first non-contact portion that is continuous with the other end in the intersecting direction of the first contact portion,
the second contact portion is provided at a center in the intersecting direction of the second plate part,
the second non-contact portion is provided at both ends in the intersecting direction of the second plate part, and includes a one end-side second non-contact portion that is continuous with one end in the intersecting direction of the second contact portion, and another end-side second non-contact portion that is continuous with the other end in the intersecting direction of the second contact portion,
one end in the intersecting direction of the one end-side first non-contact portion and one end in the intersecting direction of the one end-side second non-contact portion are connected to each other, and
the other end in the intersecting direction of the other end-side first non-contact portion and the other end in the intersecting direction of the other end-side second non-contact portion are connected to each other.

3. The battery cooler according to claim 2, wherein
each of the one end-side first non-contact portion, the other end-side first non-contact portion, the one end-side second non-contact portion, and the other end-side second non-contact portion is formed in an arcuate shape so as to be deformable in a flexural manner in the predetermined direction from a boundary portion connected to the first contact portion or the second contact portion to a distal end portion in the intersecting direction.

4. The battery cooler according to claim 2, wherein
the one end-side first non-contact portion and the one end-side second non-contact portion are formed so as to curve and extend such that a separation distance in the predetermined direction sequentially changes in the order of large → small → large, from a boundary portion connected to the first contact portion or the second contact portion to a distal end portion on one side in the intersecting direction, and to be connected to each other at one end in the intersecting direction, and
the other end-side first non-contact portion and the other end-side second non-contact portion are formed so as to curve and extend such that a separation distance in the predetermined direction sequentially changes in the order of large → small → large, from a boundary portion connected to the first contact portion or the second contact portion to a distal end portion on the other end side in the intersecting direction, and to be connected to each other at the other end in the intersecting direction.

5. The battery cooler according to claim 1, comprising an elastic body that is interposed between an inner surface of the first contact portion and an inner surface of the second contact portion, and is elastically deformable in the predetermined direction.

6. The battery cooler according to claim 5, wherein
the elastic body is disposed at a plurality of positions in the internal space, spaced apart in an intersecting direction that intersects the predetermined direction.

7. The battery cooler according to claim 6, wherein
the cooling passage is partitioned by the elastic bodies at the plurality of positions in the internal space.

8. The battery cooler according to claim 5, wherein
the elastic body is attached to a projection that projects in the predetermined direction from each of the inner surface of the first contact portion and the inner surface of the second contact portion.

9. The battery cooler according to claim 1, wherein
a thickness of the first non-contact portion is smaller than a thickness of the first contact portion, and
a thickness of the second non-contact portion is smaller than a thickness of the second contact portion.

10. A battery unit comprising: two or more battery cells arranged side by side in a predetermined direction with a predetermined space interposed therebetween; a cooler disposed in the predetermined space between the two battery cells adjacent in the predetermined direction; and a restraint member that restrains the battery cells from relatively moving in the predetermined direction, wherein
the cooler includes an outer wall that forms an internal space including a cooling passage through which a cooling fluid flows, and is deformable in a flexural manner in the predetermined direction,
the outer wall includes
a first plate part that faces one of the battery cells in the predetermined direction, and
a second plate part that faces the other battery cell in the predetermined direction, and faces the first plate part across the internal space in the predetermined direction,
the first plate part includes
a first contact portion that is in contact with an outer surface of the one of the battery cells, and
a first non-contact portion that is continuous with the first contact portion, forms a first gap, with the one of the battery cells, allowing expansion deformation of the one of the battery cells, and is not in contact with an outer surface of the one of the battery cells, and
the second plate part includes
a second contact portion that is in contact with an outer surface of the other battery cell, and
a second non-contact portion that is continuous with the second contact portion, forms a second gap, with the other battery cell, allowing expansion deformation of the other battery cell, is not in contact with the outer surface of the other battery cell, and is not in contact with an inner surface of the first non-contact portion.
